(19) United States
(12) Patent Application Publication
(10) Pub. No.: US 2025/0299219 A1
(43) Pub. Date: Sep. 25, 2025

(54) RESOURCE ALLOCATION FOR ENTITY CONNECTIONS

(71) Applicant: Verily Life Sciences LLC, Dallas, TX (US)

(72) Inventors: Sina Rashidian, Boston, MA (US); Pooyan Khajehpour Tadavani, Kitchener (CA); Yugang Jia, Boston, MA (US)

(21) Appl. No.: 19/082,465

(22) Filed: Mar. 18, 2025

Related U.S. Application Data
(60) Provisional application No. 63/568,618, filed on Mar. 22, 2024.

(51) Int. Cl. G06Q 30/0241

(52) U.S. Cl. CPC G06Q 30/0241

(57) ABSTRACT

Example systems and methods for optimizing resource allocations are provided. A computing device constructs a connection model based on a predetermined total resource allocation, a predetermined number of communication channels, multiple total target numbers of connected entities from multiple target groups, and multiple resource distribution parameters associated with the predetermined number of communication channels and the multiple target groups. The multiple resource distribution parameters for the connection model in a subsequent period can be learned and updated using an online reinforcement learning algorithm. The computing device determines optimized resource allocations for the predetermined number of communication channels in the subsequent period based on the connection model and the current connection data using one or more convex optimization algorithms.

### CROSS-REFERENCE TO RELATED APPLICATIONS

This application claims priority to U.S. Provisional Patent Application No. 63/568,618, filed Mar. 22, 2024, titled “Resource Allocation for Entity Connections,” the entirety of both of which is hereby incorporated by reference.

### FIELD

The present application generally relates to entity connections and more particularly relates to resource allocation for entity connections.

### BACKGROUND

Traditionally, clinical trials have fallen short of effectively representing certain populations. For example, related studies show that clinical trials persistently fail to proportionally represent various racial and ethnic populations. Despite not studying the effect of a therapeutic on specific subgroups, treatment providers do not restrict who is offered treatment based on the trial's demographics. Post-market, real world prescription practices ignore the generalizability limitations directly related to lack of diversity. This discordance between knowledge generation and real-world application puts underrepresented populations at risk for unpredictable harm.

Reasons for underrepresentation can include the lack of intention to consider diverse populations in clinical research, lack of incentives to study diverse populations, and persistent overlooking of diversity issues at multiple levels in research designs. Addressing more diverse populations and generating more representative clinical research programs may require more financial resources and longer time to allow for sophisticated accrual efforts, increasing the financial costs and risk to the clinical trials industry. While regulations (e.g., from the FDA) may ultimately require companies to simply comply, pharmaceutical and life science companies need viable, effective solutions for recruiting and retaining diverse populations into their studies. Thus, despite changes in regulations, the pharmaceutical and life sciences industries still lack methodologies for solving the challenge of representativeness.

### SUMMARY

Various examples are described for optimizing resource allocation for entity connections. One example method includes receiving a predetermined total resource allocation for connecting entities for a period, a predetermined number of communication channels, and multiple total target numbers of connected entities from multiple target groups. The multiple target groups are based on a plurality of demographical parameters. The example method includes constructing a connection model based on the predetermined total resource allocation, the predetermined number of communication channels, the multiple total target numbers of connected entities to be from multiple target groups, and multiple resource distribution parameters associated with the predetermined number of communication channels and the multiple target groups. The example method includes receiving current connection data corresponding to the multiple target groups from the predetermined number of communication channels during a current period via network communication. The example method includes learning the multiple resource distribution parameters for the current period from multiple explorations of the predetermined number of communication channels based on corresponding allocated exploration resources using an online reinforcement learning algorithm. The example method includes updating the multiple resource distribution parameters for the connection model in a subsequent period based on the current connection data and historical connection data. The example method includes determining optimized resource allocations for the predetermined number of communication channels in the subsequent period by maximizing a total number of connected entities from the multiple target groups and minimizing deviation from connection trajectories for the multiple target groups respectively based on multiple updated resource distribution parameters for the connection model and the current connection data using one or more convex optimization algorithms. The example method includes providing the optimized resource allocations to the predetermined number of communication channels in the subsequent period.

One example system for optimizing resource allocation for entity connections includes a non-transitory computer-readable medium; one or more processors in communication with the non-transitory computer-readable medium, the one or more processors configured to execute processor-executable instructions stored in the non-transitory computer-readable medium configured to receive a predetermined total resource allocation for connecting entities for a period, a predetermined number of communication channels, and multiple total target numbers of connected entities from multiple target groups respectively; construct a connection model based on the predetermined total resource allocation, the predetermined number of communication channels, the multiple total target numbers of connected entities from multiple target groups, and multiple resource distribution parameters associated with the predetermined number of communication channels and the multiple target groups; receive current connection data corresponding to the multiple target groups from the predetermined number of communication channels in a current period; learn the multiple resource distribution parameters for the current period from multiple explorations of the predetermined number of communication channels based on corresponding allocated exploration resources using an online reinforcement learning algorithm; update the multiple resource distribution parameters for the connection model in a subsequent period based on the current connection data and historical connection data; determine optimized resource allocations for the predetermined number of communication channels in the subsequent period by maximizing a total number of connected entities from the multiple target groups and minimizing deviation from connection trajectories for the multiple target groups respectively based on multiple updated resource distribution parameters for the connection model and the current connection data using one or more convex optimization algorithms; and provide the optimized resource allocations to the predetermined number of communication channels in the subsequent period.

One example non-transitory computer-readable medium comprising processor-executable instructions configured to cause one or more processors to receive a predetermined total resource allocation for connecting entities for a period, a predetermined number of communication channels, and multiple total target numbers of connected entities from multiple target groups respectively; construct a connection model based on the predetermined total resource allocation, the predetermined number of communication channels, the multiple total target numbers of connected entities from multiple target groups, and multiple resource distribution parameters associated with the predetermined number of communication channels and the multiple target groups; receive current connection data corresponding to the multiple target groups from the predetermined number of communication channels in a current period; learn the multiple resource distribution parameters for the current period from multiple explorations of the predetermined number of communication channels based on corresponding allocated exploration resources using an online reinforcement learning algorithm; update the multiple resource distribution parameters for the connection model in a subsequent period based on the current connection data and historical connection data; determine optimized resource allocations for the predetermined number of communication channels in the subsequent period by maximizing a total number of connected entities from the multiple target groups and minimizing deviation from connection trajectories for the multiple target groups respectively based on multiple updated resource distribution parameters for the connection model and the current connection data using one or more convex optimization algorithms; and provide the optimized resource allocations to the predetermined number of communication channels in the subsequent period.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system for optimizing resource allocation for connecting entities;

FIG. 2 shows a diagram of a process for optimizing resource allocation for entity connections;

FIG. 3 shows an example method of optimizing resource allocation for entity connections;

FIG. 4 shows an example computing device suitable for use in example systems or methods for optimizing resource allocation for entity connections according to this disclosure.

### DETAILED DESCRIPTION

Examples are described herein in the context of resource allocation for entity connections. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Traditionally, tools used to manage resource allocation are often highly manual and not scalable. More recently, digital communication platforms have become an emerging tool. However, digital communications have tended to be fixed and based on previous data consumption observations. Even when the entity connection process run through different communication channels to target specific entity groups, operators face the challenge of optimizing resource allocations to reach their target number of entities while maintaining proportional representation from different target groups during the connection process.

The present disclosure proposes parametric modeling techniques to resource allocation for entity connection from different target groups. The multiple target groups are defined to ensure that the connected entities have diverse characteristics.

Reinforced learning can be used to process information over time to learn one or more resource distribution parameters. A resource distribution parameter represents an average number of connected entities from a target group by consuming a unit resource on a communication channel. The online reinforcement learning technique can estimate the resource distribution parameters after determining from different target groups and updated for each period. The estimates of resource distribution parameters can be generated weekly or at any suitable cadence based on historical connection data. In this example, greater weights are given to the more recent connection data.

A resource allocation mechanism considers a trajectory based on the number of connected entities, breaking down the entire connection timeframe into individual weeks or the selected update cadence, e.g., daily, bi-weekly, etc. The aim can be to connect the desired number of entities evenly during the selected period, e.g., week by week. For instance, if the goal is to connect 100 entities for each of target groups A, B, and C over a period of 10 weeks, the initial trajectory would be set to (A=10, B=10, C=10) for each week. The trajectory is then reassessed after each week, to maintain the balance of connected entities from different target groups. For example, if in the first week, 15, 8, and 10 connected entities are from target groups A, B, and C respectively, the trajectory for the second week can be updated to A=9.44, B=10.22, C=10, to spread the compensation over the remainder of the rest of connection periods. Alternatively, the trajectory can be updated only for the next period. For example, the trajectory for the second week can be updated to A=5, B=12, C=10, to compensate for the deviations early on in the connection process rather than letting them accumulate until the end.

After establishing the target numbers according to the designed trajectory and estimating the resource distribution parameters from the collected data, resources can be optimized among different communication channels for each week. An optimization model can be built based on a restless multi-armed bandit challenge to generate sequential resource allocation strategies based on the size and distribution parameter of the target groups. For example, with a fixed total weekly resource amount, resources for different communication channels can be optimized with the aim of maximizing the expected total number of connected entities while minimizing deviations from the trajectory (e.g., via quadratic optimization). Alternatively, or additionally, the optimization objective can be maximizing the expected total number of connected entities while maximizing the portion of the connected entities completely aligned with the trajectory (e.g., via linear program optimization). The balance between maximizing the number of connected entities and deviating from the trajectory can be modulated by setting a hyperparameter for relaxing the optimization model to represent the desired balance at any given time.

Because this approach learns model parameters based on past connection performance, it is imperative to allocate sufficient resources to obtain interpretable results. A connection operation consistently at low resource makes it challenging to differentiate whether underperformance is due to inherent methodological issues or to resource constraints. To address this, a dynamic method can be implemented to set minimum resource amount for each operation (based on the multi-armed bandit problem) enforced through optimization constraints. This approach ensures that a portion of the resource is allocated for exploration, and this portion gradually decreases as more confidence is gained in the learned parameters of the campaigns.

One example allows for optimizing resource allocation to achieve several objectives simultaneously. For example, speed, cost control, and demographic diversity all become applied considerations. Such an approach allows for proactive adjustment of resource spend within a period to maximize demographic diversity as an outcome rather than only analyzing whether the entire approach has been successful, post-connection. The method can achieve the minimum spend and time required to conduct a test resulting in accurate results applicable to different demographic groups.

In addition, digital communication platforms are employed in this disclosure to allows for scaling as they mitigate the dependence on local individuals. In addition, the approach is inherently flexible as it contemplates adjustability in the connected entities for diverse characteristics for a test. For example, the test may be a clinical trial and the objects may be clinical trial candidates. As the epidemiology of the given diseases of interest may vary, the target numbers of clinical trial candidates can be adjusted based on the requirements for the clinical trial. Moreover, the model can adjust in response to unforeseen shifts in study candidates' reactions, which could be based on the treatment area, or other externalities.

This illustrative example is given to introduce the reader to the general subject matter discussed herein and the disclosure is not limited to this example. The following sections describe various additional non-limiting examples and examples of optimizing budget allocation and maintaining demographic diversity for clinical trial recruitment.

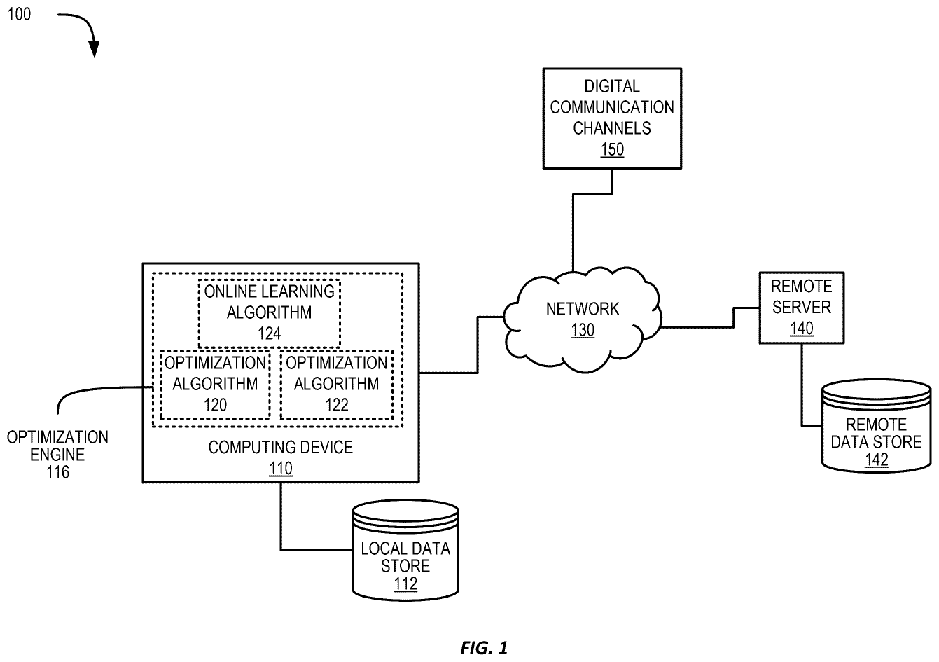

Referring now to FIG. 1, FIG. 1 shows an example system 100 for optimizing resource allocation for connecting entities. The system 100 includes a computing device 110 in network communication with multiple digital communication channels 150. The digital communication channels 150 can include multiple digital advertising platforms for deploying digital operations for connecting entities. The computing device 110 includes an optimization engine 116 configured to optimize entity connection and a local data store 112. Alternatively, the local data store 112 are part of the computing device 110. The computing device 110 is also connected to a remote server 140 via communication network 130. The remote server 140 is, in turn, connected to a remote data store 142.

The computing device 110 can receive a predetermined total resource allocation for connecting entities for a period, a predetermined number of digital communication channels for entity connections, multiple target groups, and total target numbers of connected entities from the multiple target groups respectively. The total resource allocation, the digital communication channels, the multiple target groups, and the multiple total target numbers from the multiple target groups can be predetermined by an operator associated with entity connection. The multiple target groups are based on a variety of demographical parameters, for example race, ethnicity, gender, and age. The operator associated with the entity connection can predefine the multiple target groups and corresponding target numbers of connected entities from the multiple target groups to ensure representation. For example, the entity connection is clinical trial recruitment, the multiple target groups are multiple cohorts with different demographic parameters. The multiple cohorts and the target numbers of clinical trial candidates recruited from the multiple cohorts can be predefined to ensure different population groups that can use the medicine, medical device, or other products or services for treatment are represented adequately in the corresponding clinical trial. The operator can create an entity connection profile, including the total resource allocation for connecting entities for each period or multiple periods, the predetermined number of digital communication channels to be employed, the multiple target groups, and the multiple total target numbers of connected entities from the multiple target groups. The entity connection profile can be stored in the local data store 112.

The optimization engine 116 on the computing device 110 can build a connection model. The recruitment model can be based on a Poisson distribution, where the total number of connected entities via a digital communication channel for a period is proportional to the resource allocated to a digital communication channel. In addition, for each digital communication channel, the number of connected entities from different target groups follow a multinomial distribution. In some examples, the connection model is a combined connection function of digital communication channels and target groups. The combined connection function includes resource distribution parameters, for example an average number of connected entities from a target group by spending S1 on a communication channel.

In some examples, the optimization engine 116 implements an online learning algorithm 124 to learn the resource distribution parameters, based on temporal recency and historical connection data related to the digital communication channels and the multiple target groups. Examples of online learning algorithm 124 can include an epsilon-greed or (“e-greedy”) method, an optimistic initialization method, an upper confidence bound (UCB) algorithm, and a Thompson sampling algorithm.

The optimization engine 116 can implement one or more optimization algorithms (e.g., optimization algorithm 120 and optimization algorithm 122) to determine optimized resource allocations for different digital communication channels by minimizing connection cost and time while maximizing the number of connected entities from each target group toward the target number for each target group. The one or more optimization algorithms can include a linear programming algorithm, a quadratic programming algorithm, or their variations. In one example, the linear programing algorithm and the quadratic programming algorithm are used, shown as optimization algorithms 120 and 122 respectively in FIG. 1. The optimization algorithms 120 and 122 are just examples of optimization algorithms that be used for connection optimization. There can be one optimization algorithm, two different optimization algorithms, or more than two different optimization algorithms in the optimization engine 116. One optimization algorithm or multiple optimization algorithms can be implemented in parallel, for example executed at the same time, or in series, for example executed one after the one.

In some examples, the optimization engine 116 generates a connection trajectory over an overall period corresponding to a target group. In an example for clinical trial recruitment, the connection trajectory is a recruitment trajectory, and connecting entities is recruiting clinical trial candidates. In a clinical trial recruitment, the total target number for a cohort of black males aged from 25 to 35 is 1000, the total target number for a cohort of white males aged from 25 to 35 is 1000, and the overall period is 10 weeks. The total target number can be divided to 10 weekly target numbers, which can be 100. Thus, the recruitment trajectory for the cohort of black males aged from 25 to 35 can include a weekly target of 100 recruits over 10 weeks, and the recruitment trajectory for the cohort of white males aged from 25 to 35 can include a weekly target of 100 recruits over 10 weeks. During a first week, 110 white males aged from 25 to 35 are recruited, and 90 black males aged from 25 to 35 are recruited. To hit the total target number of 1000 for each cohort group, the optimization engine 116 can update the weekly target number for the following nine weeks as 98.9 for the cohort group of white males aged from 25 to 35 and 100.1 for the cohort group of black males aged from 25 to 35. Alternatively, the optimization engine 116 can update the weekly target number for the immediate subsequent week as 90 for the cohort group of white males aged from 25 to 35 and 110 for the cohort group of black males aged from 25 to 35. The former can alleviate a burden for a single week by spreading the compensation over the rest of the weeks. The disadvantage is that if a cohort constantly underperforms, its shortcoming can accumulate and becomes more evident toward the end of the recruitment, which can be too late to be fixed. The latter can fix the deviations early on during the recruitment rather than letting them accumulate until the end. There can be a hybrid approach of updating weekly targets by compensating the deviation from the first week during a subset of the rest of the weeks, for examples during the next three or four weeks of the nine following weeks.

In some examples, certain constraints may need to be relaxed to achieve a feasible solution for an optimization function. For example, the group constraint associated with the target groups can be relaxed so that the optimization can be achieved by maximizing the total number of connected entities while minimizing the deviation from the target numbers of connected entities from different target groups, that is, maximally tracking the connection trajectory. The optimization engine 116 can implement an optimization algorithm 120, which can be a flexible linear programming algorithm, to maximize the recruitment to be aligned with the trajectory by relaxing the group constraint while minimizing the over-connection caused by the relaxation. Alternatively, or additionally, the optimization engine 116 can implement an optimization algorithm 122, which can include a quadratic programming algorithm, to relax the cohort constraint by providing a penalizing weight for divergences from a connection trajectory for a target group. Both the flexible linear programming algorithm and the quadratic programming algorithm are convex, thus a global optimal point can be achieved with convergence. In some examples, achieving the global optimal point may be computationally complex, which consumes a lot of computational resource (e.g., processing power or memory). An approximation threshold can be predefined. For example, if the result of the optimization function achieves 95% of the absolute global optimal point, the optimization process can be considered as finished. In other words, connected entities from different target groups can be obtained at a reasonable proportion with actionable resource allocation. In other examples, the maximization of the total number of connected entities and minimization of divergence from the connection trajectories for different target groups can be achieved when the deviation satisfies a predetermined deviation threshold during a predetermined period.

The connection optimization engine 115 can determine optimized resource allocations for different digital communication channels for the subsequent period. The different digital communication channels use the allocated resources to connect entities from the multiple target groups. The allocated resource information and the connection data from different digital communication channels can be stored in the local data store 112.

In some examples, the optimization engine 116 on the computing device 110 is provided by the remote server 140. In some examples, the remote server 140 includes the optimization engine 116 for optimizing entity connection.

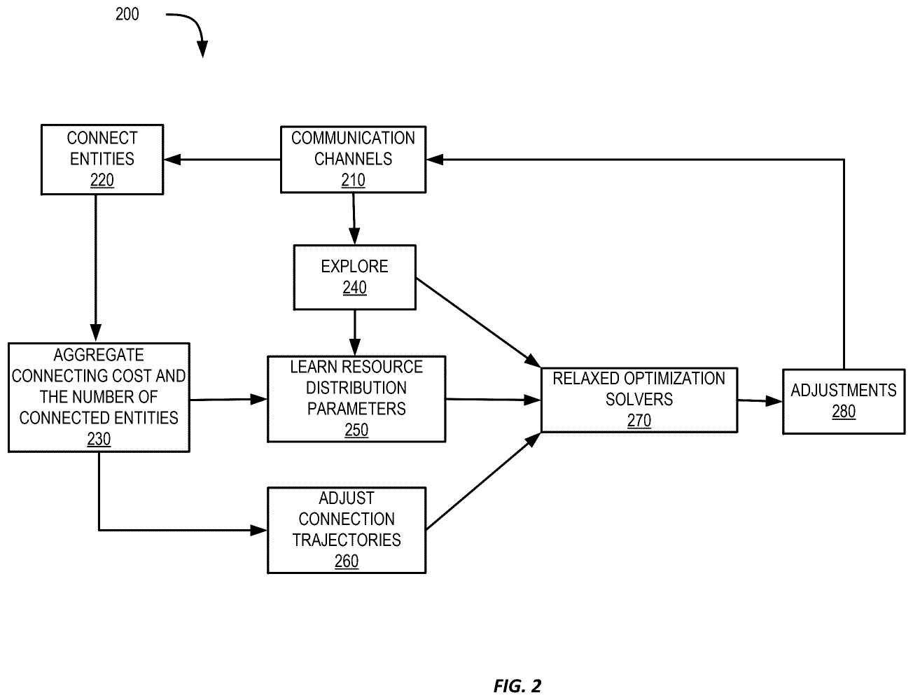

Referring now to FIG. 2, FIG. 2 shows a diagram of a process 200 for optimizing resource allocation for entity connections. In FIG. 2, during the current period, multiple communication channels 210 receives respective allocated resources determined at the end of the previous period. The communication channels 210 then uses the allocated resources to develop and deploy connection tools or operations for connecting entities 220. A computing device can aggregate connecting cost and the number of connected entities 230 by different communication channels 210 continuously during the current period.

The aggregated connecting cost and the aggregated number of connected entities during the current period can be used for adjusting connection trajectories 260 for different target groups. The aggregated connecting cost and the aggregated number of connected entities during the current period can also be used for learning resource distribution parameters 250. Meanwhile, the communication channels 210 also explore 240 (e.g., test, trial and error) different operations or scenarios for learning resource distribution parameters 250. Learned resource distribution parameters, adjusted connection trajectories for different target groups, and the exploration costs can be considered in an optimization function.

However, the optimization function can be extremely restrictive to meet all the total target numbers of connected entities from all the predetermined target groups with a predetermined total resource allocation. One or more relaxed optimization solvers 270 can relax the group constraint to achieve a feasible solution, for example resource allocations among different communication channels, for the optimization function. Alternatively, or additionally, an operator can also relax the total resource allocation or total time constraint for the clinical trial recruitment. An operator of an entity connection project can make certain manual adjustments 280 of the optimization results from the relaxed optimization solvers 270. For example, an operator can reduce or increase a resource allocation to a communication channel based on certain new information about the communication channel not considered in the optimization function, such as a negative or positive marketing report being published for the communication channel. Then the optimized resource allocations are provided to different communication channels for connecting entities during the subsequent period. This way, the connection process is optimized at every period until the entire entity connection process is completed.

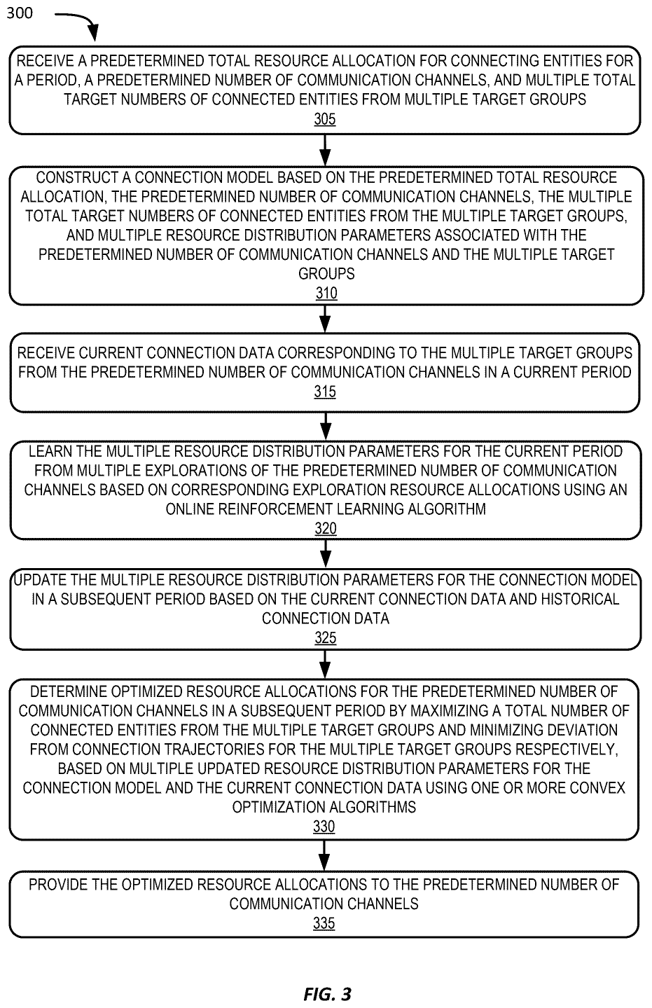

Referring now to FIG. 3, FIG. 3 shows an example method 300 of optimizing resource allocation for entity connections. The method 300 will be describe with respect to the example system 100 shown in FIG. 1 and the process 200 shown in FIG. 2; however, any suitable system according to this disclosure may be used.

At block 305, a computing device 110 receives a predetermined total resource allocation for connecting entities for a period, a predetermined number of communication channels, and multiple total target numbers of connected entities from multiple target groups, respectively.

In some examples, the predetermined total resource allocation is a predetermined total budget, connecting entities is clinical trial recruitment, the connected entities are recruited clinical trial candidates, the period is a recruitment period, the communication channels are recruitment channels, and the target groups are cohort groups. The predetermined total budget B for clinical trial recruitment for a recruitment period can be a weekly budget. Alternatively, the predetermined total budget B can be a monthly budget, or a budget in a period of other suitable length. The predetermined number of recruitment channels can be preselected digital advertising channels, for example Google Ads, Facebook Ads, etc. Digital advertisement tools can be designed to use advertisement related metrics such as clickthrough rate to measure the performance of a digital recruitment channel. Each recruitment channel can specify how to reach the audience, target areas, creatives (e.g., advertisements), etc. Recruitment channels recruit a mixed group of candidates, which can belong to different predefined cohort groups.

The multiple cohort groups are based on a plurality of demographical parameters. An operator of the clinical trial recruitment can set multiple cohort groups for recruitment to ensure the trial results represent the target population that can use the medicine or medical device to be tested in the clinical trial. A cohort group c can be described by a combination of race, gender, age, or other demographic characteristics. For example, a cohort group is African American aged between 20 and 40. The operator can set a total target number p_{c} for each defined cohort group. Then an overall total target number P for the clinical trial recruitment can be described as shown in Equation 1 and a target stratification ratio of cohort c can be denoted as ρ_{c} as shown in Equation 2.

$${\sum }_{c = 1}^{C} {p}_{c} = P \qquad ( 1 )$$

$${ρ}_{c} = \frac{{p}_{c}}{P} \qquad ( 2 )$$

Assuming the advertising budget B is fixed for a certain period of time, e.g. a weekly budget, each week, the problem is how to distribute the total budget among A predetermined recruiting channels. As shown in Equation (3), each recruitment channel receives a budget bₐ for recruiting candidates for the clinical trial.

$${\sum }_{a = 1}^{A} {b}_{a} = B \qquad ( 3 )$$

At block 310, the computing device 110 constructs a connection model based on the predetermined total resource allocation, the predetermined number of communication channels, the multiple total target numbers of connected entities from the multiple target groups, and multiple resource distribution parameters related to the predetermined number of communication channels and the multiple target groups.

For the example at block 310, the connection model is a recruitment model, and the multiple resource distribution parameters are budget distribution parameters. For each recruitment channel, it can be assumed that the total number of recruits for each recruitment period follows a Poisson distribution. Thus, the mean value of the total number of recruits is expected to be proportional to the budget allocated to the recruitment channels. Moreover, for each recruitment channel, the distribution of the number of recruits from different cohort groups follows a multinomial distribution. In this example, a combined recruitment function based on a Poisson distribution can be used to describe the recruits from cohort c by recruitment channel a. The mean value λ_{a,c} of the recruitment number from cohort c by recruitment channel a can be described as in Equation (4). In Equation (4), R_{a,c} is a budget distribution parameter, which is an expected number of recruits from cohort c by spending $1 on recruitment channel a. A parameter matrix R_{A×C} can be formed including budget distribution parameters corresponding to different recruitment channels and cohort groups.

$${λ}_{a , c} = {b}_{a} {R}_{a , c} \qquad ( 4 )$$

The expected number of recruits from cohort c in one week can be expressed as in Equation (5). The expected total weekly recruits Q can be obtained as shown in Equation (6).

$${q}_{c} = {\sum }_{a = 1}^{A} {b}_{a} {R}_{a , c} \qquad ( 5 )$$

$$Q = {\sum }_{c = 1}^{C} {q}_{c} = {\sum }_{c = 1}^{C} {\sum }_{a = 1}^{A} {b}_{a} {R}_{a , c} \qquad ( 6 )$$

At block 315, the computing device 110 receives current connection data corresponding to the multiple target groups from the predetermined number of communication channels during a current period. Following the example of clinical trial recruitment described above, the current period is the current recruitment period. At the end of the current recruitment period, a recruitment matrix Z_{A×C} can be obtained representing aggregated current recruitment data, including the number of recruited participants from each cohort by each recruitment channel. The target recruitment number from each cohort group in the subsequent recruitment period can be updated based on Equation (7), and the overall total target number and the target stratification ratios can be obtained accordingly.

$${p}_{c} ← Max ( {p}_{c} - {\sum }_{a = 1}^{A} {Z}_{a , c} , 0 ) \qquad ( 7 )$$

It is possible that some cohort groups have more recruited participants than what is needed. An overshoot number for cohort group c can be defined as shown in Equation (8). The total overshoot cost can be defined as shown in Equation (9), where ω is a weight or the unit cost for one overshoot participant from a cohort group.

$${o}_{c} ← Max ( {\sum }_{a = 1}^{A} {Z}_{a , c} - {p}_{c} , 0 ) \qquad ( 8 )$$

$$Ω = ω {\sum }_{c = 1}^{C} {o}_{c} \qquad ( 9 )$$

At block 320, the computing device 110 learns the multiple resource distribution parameters for the current period from multiple explorations of the predetermined number of communication channels based on corresponding exploration resources using an online reinforcement learning algorithm. In the clinical trial recruitment example, the exploration budgets are exploration resources. The budget distribution parameter R_{a,c} can be an expected number of recruits from cohort c by spending 1$ on recruitment channel a as described at block 310. The budget distribution parameters can be initialized based on previous recruitment data and other related data, for example marketing data and census reports. The budget distribution parameters related to a recruitment channel and a cohort group can be learned via online reinforcement learning over time.

In some examples, certain budget needs to be allocated for a recruitment channel to explore different campaigns to learn the budget distribution parameter. For example, a large portion of the total budget B (e.g., 50%) can be set for exploration initially, and the portion can be decreased gradually. In some examples, the exploration budget can be decreased by rate of \sqrt{ln/t}, based on a UCB algorithm. In other examples, other suitable online learning algorithms can be used. The exploration budgets can be distributed among the recruitment channels based on corresponding historical budgets. For example, the exploration budget for recruitment channel a during recruitment period t, is proportional to (Σ_{τ=1}^{t}bₐ^{τ})^{-0.5}. In general, the larger the budget for a recruitment channel is, the higher the confidence level for the budget distribution parameter can be.

At block 325, the computing device 110 updates the multiple resource distribution parameters for the connection model in a subsequent period based on the current connection data and historical connection data.

The current connection data can be current recruitment data and the historical connection data can be historical recruitment data in the clinical trial recruitment example. In some examples, the notion of time (e.g., week number) can be considered and historical recruitment data can be used during the online reinforcement learning. The probability of observing Z_{a,c}^{t} recruits from cohort group c by spending the budget bₐ^{t} in week ton recruitment channel a can be expressed as shown in Equation (10), based on a Maximum Likelihood Estimation problem.

$$Poisson ( x = {Z}_{a , c}^{t} \vert λ = {b}_{a}^{t} {R}_{a , c} ) = {e}^{- {b}_{a}^{t} {R}_{a , c}} {( {b}_{a}^{t} {R}_{a , c} )}^{{Z}_{a , c}^{t}} \div {Z}_{a , c}^{t} ! \qquad ( 10 )$$

The likelihood of observing all historical recruitment numbers for recruitment channel a and cohort group c is shown in Equation (11), and the log likelihood is shown in Equation (12).

$$Likelihood = \text{?} ( \text{?} \div \text{?} ! \qquad ( 11 )$$

$$Log Likelihood = \text{?} Ln ( \text{?} {R}_{a , c} ) - \text{?} {R}_{a , c} + Const . \qquad ( 12 )$$

$$\text{?} \text{indicates text missing or illegible when filed}$$

By taking derivative of the log likelihood and setting the derivative to zero, the budget distribution parameter can be obtained as shown in Equation (13).

$$\frac{\partial }{\partial {R}_{a , c}} LL = O {R}_{a , c} = \text{?} \div \text{?} \qquad ( 13 )$$

$$\text{?} \text{indicates text missing or illegible when filed}$$

The budget distribution number R_{a,c} can be updated for every recruitment period. The budget distribution number R_{a,c} for the subsequent recruitment period can be estimated based on the aggregated recruitment data and allocated budgets in the current recruitment period and the previous recruitment periods. The more recent recruitment data and budget can more influence on the budget distribution parameter for the subsequent recruitment period.

At block 330, the computing device 110 determines optimized resource allocations for the predetermined number of communication channels in the subsequent period by maximizing a total number of connected entities from the multiple target groups and minimizing deviation from connection trajectories for the multiple target groups respectively, based on multiple updated resource distribution parameters for the connection model and the current connection data using one or more convex optimization algorithms. In the clinical trial recruitment example, the resource allocations are recruitment budgets, and the total number of connected entities is a total recruitment number. In some examples, a minimum amount and a maximum allowed amount are set to limit the recruitment budget for each recruitment channel so that the average rate of recruiting can be assumed to be linear to the recruitment budget. Recruitment data from previous recruitment periods and the current recruitment period can be accrued to determine the target numbers in subsequent recruitment periods. In some examples, an optimization objective is to minimize the budget spent in a recruitment period, assuming there is enough budget to recruit the total target numbers of clinical trial candidates from predefined cohort groups. The optimization function can be described as shown in Equation (14).

$$b = Arg Min {\sum }_{a = 1}^{A} {b}_{a} s . t . ∀ c : {q}_{c} = {p}_{c} , {b}_{Min} \leq {b}_{a} \leq {b}_{Max} , {\sum }_{a = 1}^{A} {b}_{a} \leq B \qquad ( 14 )$$

However, the optimization problem in Equation (14) can be very restrictive and may not have a feasible solution. In some examples, certain constrains can be relaxed, for examples by including an overshooting cost as described in Equation (9). Thus, the optimization function can be described as shown in Equation (15).

$$b = Arg Min {\sum }_{a = 1}^{A} {b}_{a} + ω {\sum }_{c = 1}^{C} {o}_{c} s . t . ∀ c : {q}_{c} \geq {p}_{c} , \qquad ( 15 )$$

$${b}_{Min} \leq {b}_{a} \leq {b}_{Max} , {\sum }_{a = 1}^{A} {b}_{a} \leq B$$

Since ωΣ_{c=1}^{C}p_{c} is a constant, it can be added to Equation (15), and the objective function can then be described as shown in Equation (16).

$$b = Arg Min {\sum }_{a = 1}^{A} {b}_{a} + ω {\sum }_{c = 1}^{C} {q}_{c} s . t . ∀ c : {q}_{c} \geq {p}_{c} , \qquad ( 16 )$$

$${b}_{Min} \leq {b}_{a} \leq {b}_{Max} , {\sum }_{a = 1}^{A} {b}_{a} \leq B$$

Based on Equations (6) and (16), the objective function can be rewritten based on the budget vector and the parameter matrix R_{A×C}, as shown in Equation (17).

$$b = Arg Min {( ω R {1}_{c} + {1}_{A} )}^{⊤} b s . t . {R}^{⊤} b \geq p , {b}_{Min} {1}_{A} \leq b \leq {b}_{Max} {1}_{A} , \qquad ( 17 )$$

$${1}_{N}^{⊤} b \leq B$$

In some examples, there is not enough budget for recruiting all the total target numbers of clinical trial candidates from all cohort groups. The optimization object is not to minimize the budget spent in a recruitment period, but a different one, for example, to maximize the total number of recruits to achieve the total target numbers of clinical trial participants recruited from all cohort groups. The period target number of clinical trial participants recruited from a cohort group can be updated for each recruitment period based on the recruits in the previous period. To ensure that the total target numbers are achieved, the period target number for each cohort group can be proportional to the total target number. In some examples, the optimization objective is to maximize the total number of recruits while minimizing deviation from a trajectory to achieve the total target number of recruits from a cohort group. Thus, the optimization function can be described as in Equation (18).

$$b = Arg Max {\sum }_{c = 1}^{C} {q}_{c} s . t . ∀ c : {q}_{c} = {ρ}_{c} Q , {b}_{Min} \leq {b}_{a} \leq {b}_{Max} , \qquad ( 18 )$$

$${\sum }_{a = 1}^{A} {b}_{a} = B$$

In some examples, the number of recruitment channels are far greater than the number of predefined cohort groups, and the optimization function may not have a feasible solution. The cohort constraint (e.g., representing demographic diversity or equality) can then be relaxed to obtain a feasible solution, for example using a flexible linear programming algorithm. With flexible linear programming, an auxiliary variable L can be introduced to represent the part of the recruitment Q that is aligned with the recruitment trajectory to the target number, and a tuning parameter φ to tune the difference between L and Q. The optimization function can be described as in Equation (19).

$$objective = Max ( 1 - φ ) L - φ ( {\sum }_{c = 1}^{C} {q}_{c} - L ) = Max ( L - φ Q ) \qquad ( 19 )$$

$$s . t . {q}_{c} \geq {ρ}_{c} L , L \geq 0 , {b}_{Min} \leq {b}_{a} \leq {b}_{Max} , {\sum }_{a = 1}^{A} {b}_{a} = B$$

The tuning parameter o, which is between 0 and 1, can be adjusted to control the balance between the total recruitment Q and over-recruitment. If φ is 1, the optimization only minimizes the deviation and ignores maximizing the total recruitment. If φ is 0, the optimization only maximizes L, without considering the deviation.

In the flexible linear programming described above, the optimization function still tries to recruit from all cohorts proportionally. Alternatively, or additionally, the cohort constraint can be modified as a weighted penalty term as shown in Equation (20). The optimization can be solved using a quadratic programming algorithm.

$$b = Arg Max {\sum }_{c = 1}^{C} {q}_{c} - {{φ}_{c} ( {q}_{c} - {ρ}_{c} Q )}^{2} s . t . {b}_{Min} \leq {b}_{a} \leq {b}_{Max} , \qquad ( 20 )$$

$${\sum }_{a = 1}^{A} {b}_{a} = B$$

The weight parameter φ_{c} penalizes deviation from the trajectory for a cohort group. The weight parameter φ_{c} can be manually set based on the importance or rarity of a cohort. For example, if the cohort is not important or is a small portion of the overall population, the weight parameter φ_{c} is set at 0, it means the cohort is not important for the clinical trial. By increasing φ_{c}, the optimization can push the expected total weekly recruits q_{c} to be more aligned with the trajectory to the target.

The optimizations relaxed based on linear programming and quadratic programming as described above both try to hit the recruitment target at a semi-uniform recruitment speed. For example, there are two cohorts, c1 and c2. The target number is 1000 for each cohort group. In the first week, the optimization tries to recruit the same number of participants from both cohort groups at the same rate. By the end of the first week, 11 participants are recruited from cohort group c1 and 9 participants are recruited from cohort group c2. For the second week, the stratification ratios from cohort group c1 and cohort group c2 are 0.4995 and 0.5005 based on corresponding 989 and 991 remaining targets, which means only 0.1% change compared to the first week. Thus, the target for the two cohort groups would roughly be (9.99, 10.01) for the second week. The target for the following week can be adjusted based on the recruits during the current week. Therefore, this can be called a dynamic trajectory approach. By not changing the targets very significantly, the stress on the optimization and weekly recruitments is lower. However, if a cohort constantly underperforms, its shortcoming will accumulate, and only be evident in the ending weeks of the trial, which could be too late to be fixed.

In some examples, a fixed trajectory approach can be implemented. With the fixed trajectory approach, the target ratio ρ is set only once, and then each week, the goal is to recruit such that the ratio of accumulated recruits for all cohort get as close as possible to ρ. In other words, the optimization attempts to compensate for whatever divergence has happened in the past week. following the example above, this means that the target for cohort group C2 is now 2 more than the target of cohort group C1. In comparison to the dynamic trajectory approach where the target for two cohorts would roughly be (9.99, 10.01), here the targets are (9, 11). This goal is more ambitious for the weekly optimizations, but in this way the errors or deviations can be fixed early on in the trial rather than letting them accumulate until the end. Another advantage is that the effect of the penalizing factors φ_{c} for the majority cohorts is already included in the targets, and so only one unified penalizing factor can be considered for all cohorts. The flexible linear programming and quadratic programming described above can be modified using a fixed trajectory approach to relax the cohort constraint to achieve optimization.

At block 335, the computing device 110 provides the optimized resource allocations to the predetermined number of communications channels. In the clinical trial recruitment example, the optimized recruitment budgets can be manually adjusted by an operator of the clinical trial recruitment before allocating the optimized recruitment budgets to the predetermined number of recruitment channels. The recruitment channels then use the allocated budgets to recruit participants for the clinical trial during the subsequent recruitment period.

The example process 300 is performed by the computing device 110. Alternatively, the example process 300 can be performed by the remote server 140. The process 300 illustrates a method for optimizing entity connection. However, not every step in the example process 300 is needed, or some other steps may be added. The process 300 can be implemented iteratively or repeatedly until the entity connection process is completed, for example the entire resource allocation is exhausted, or the target numbers of connected entities from certain target groups are achieved.

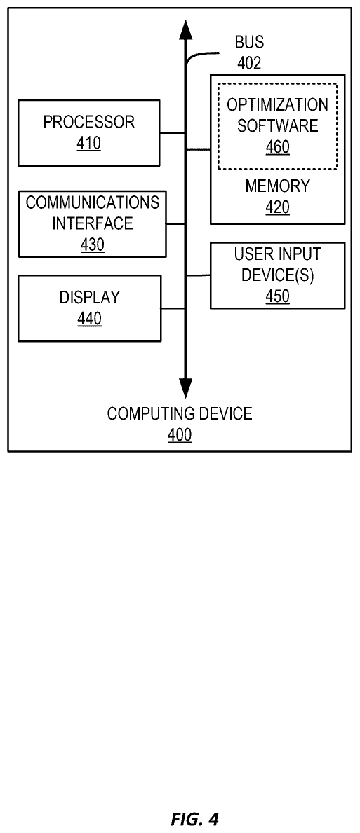

Referring now to FIG. 4, FIG. 4 shows an example computing device 400 suitable for use in example systems or methods for optimizing entity connection according to this disclosure. The example computing device 400 includes a processor 410 which is in communication with the memory 420 and other components of the computing device 400 using one or more communications buses 402. The processor 410 is configured to execute processor-executable instructions stored in the memory 420 to perform one or more methods for according to different examples, such as part or all of the example method 300 described above with respect to FIG. 3. In this example, the memory 420 includes an optimization software 460, such as the optimization engine 116 in the example system 100 shown in FIG. 1. In addition, the computing device 400 also includes one or more user input devices 450, such as a keyboard, mouse, touchscreen, microphone, etc., to accept user input; however, in some examples, the computing device 400 may lack such user input devices, such as remote servers or cloud servers. The computing device 400 also includes a display 440 to provide visual output to a user.

The computing device 400 also includes a communications interface 430. In some examples, the communications interface 430 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one.” or example,” “in an example,” “in one implementation,” or “in an implementation,” variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a predetermined total resource allocation for connecting entities for a period, a predetermined number of communication channels, and multiple total target numbers of connected entities from multiple target groups, wherein the multiple target groups are based on a plurality of demographical parameters;
constructing a connection model based on the predetermined total resource allocation, the predetermined number of communication channels, the multiple total target numbers of connected entities to be from multiple target groups, and multiple resource distribution parameters associated with the predetermined number of communication channels and the multiple target groups;
receiving current connection data corresponding to the multiple target groups from the predetermined number of communication channels during a current period via network communication;
learning the multiple resource distribution parameters for the current period from multiple explorations of the predetermined number of communication channels based on corresponding allocated exploration resources using an online reinforcement learning algorithm;
updating the multiple resource distribution parameters for the connection model in a subsequent period based on the current connection data and historical connection data;
determining optimized resource allocations for the predetermined number of communication channels in the subsequent period by maximizing a total number of connected entities from the multiple target groups and minimizing deviation from connection trajectories for the multiple target groups respectively based on multiple updated resource distribution parameters for the connection model and the current connection data using one or more convex optimization algorithms; and
providing the optimized resource allocations to the predetermined number of communication channels in the subsequent period.

2. The method of claim 1, wherein the period is a week, wherein the current period is a current week, and wherein the subsequent period is a subsequent week following the current week.

3. The method of claim 1, wherein the predetermined number of communication channels comprises one or more digital advertising platforms.

4. The method of claim 1, wherein the current connection data comprises aggregated numbers of connected entities from the multiple target groups via the predetermined number of communication channels based on current resource allocations in the current period.

5. The method of claim 1, wherein the online reinforcement learning algorithm comprises an upper confidence bound algorithm, wherein the multiple explorations comprise multiple testing operations in a communication channel.

6. The method of claim 1, further comprising:
determining the optimized resource allocations for the predetermined number of communication channels during the subsequent period further based on the allocated exploration resources.

7. The method of claim 1, further comprising:
determining the optimized resource allocations for the predetermined number of communication channels in the subsequent period by minimizing a total resource allocation.

8. The method of claim 1, further comprising:
determining the connection trajectories by proportionating the multiple total target numbers of connected entities from the multiple target groups over a total period; and
adjusting the connection trajectories based on the current connection data corresponding to the multiple target groups from the predetermined number of communication channels during the current period.

9. The method of claim 1, wherein the one or more convex optimization algorithms comprises a flexible linear programming model, wherein the method further comprises relaxing one or more constraints associated with the multiple total target numbers of connected entities from multiple target groups based on the flexible linear programming model.

10. The method of claim 1, wherein the one or more convex optimization algorithms comprise a quadratic programming model, wherein the method further comprises relaxing one or more constraints associated with the multiple total target numbers of connected entities from multiple target groups based on the quadratic programming model.

11. A system comprising:
a non-transitory computer-readable medium;
one or more processors in communication with the non-transitory computer-readable medium, the one or more processors configured to execute processor-executable instructions stored in the non-transitory computer-readable medium configured to cause the one or more processors to:
receive a predetermined total resource allocation for connecting entities for a period, a predetermined number of communication channels, and multiple total target numbers of connected entities from multiple target groups respectively, wherein the multiple target groups are based on a plurality of demographical parameters;
construct a connection model based on the predetermined total resource allocation, the predetermined number of communication channels, the multiple total target numbers of connected entities from multiple target groups, and multiple resource distribution parameters associated with the predetermined number of communication channels and the multiple target groups;
receive current connection data corresponding to the multiple target groups from the predetermined number of communication channels in a current period;
learn the multiple resource distribution parameters for the current period from multiple explorations of the predetermined number of communication channels based on corresponding allocated exploration resources using an online reinforcement learning algorithm;
update the multiple resource distribution parameters for the connection model in a subsequent period based on the current connection data and historical connection data;
determine optimized resource allocations for the predetermined number of communication channels in the subsequent period by maximizing a total number of connected entities from the multiple target groups and minimizing deviation from connection trajectories for the multiple target groups respectively based on multiple updated resource distribution parameters for the connection model and the current connection data using one or more convex optimization algorithms; and
provide the optimized resource allocations to the predetermined number of communication channels in the subsequent period.

12. The system of claim 11, wherein the period is a week, wherein the current period is a current week, and wherein the subsequent period is a subsequent week following the current week, wherein the predetermined number of communication channels comprises one or more digital advertising platforms.

13. The system of claim 11, wherein the current connection data comprises aggregated numbers of connected entities from the multiple target groups via the predetermined number of communication channels based on current resource allocations in the current period.

14. The system of claim 11, wherein the one or more processors are configured to execute further processor-executable instructions stored in the non-transitory computer-readable medium to:
determine the optimized resource allocations for the predetermined number of communication channels during the subsequent period further based on the allocated exploration resources.

15. The system of claim 11, wherein the one or more processors are configured to execute further processor-executable instructions stored in the non-transitory computer-readable medium to:
determine the connection trajectories by proportionating the multiple total target numbers of connected entities from the multiple target groups over a total period; and
adjust the connection trajectories based on the current connection data corresponding to the multiple target groups from the predetermined number of communication channels during the current period.

16. The system of claim 11, wherein the one or more convex optimization algorithms comprise a flexible linear programming model, wherein the one or more processors are configured to execute further processor-executable instructions stored in the non-transitory computer-readable medium to:
relax one or more constraints associated with the multiple total target numbers of connected entities from multiple target groups based on the flexible linear programming model.

17. The system of claim 11, wherein the one or more convex optimization algorithms comprise a quadratic programming model, wherein the one or more processors are configured to execute further processor-executable instructions stored in the non-transitory computer-readable medium to:
relax one or more constraints associated with the multiple total target numbers of connected entities from multiple target groups based on the quadratic programming model.

18. A non-transitory computer-readable medium comprising processor-executable instructions configured to cause one or more processors to:
receive a predetermined total resource allocation for connecting entities for a period, a predetermined number of communication channels, and multiple total target numbers of connected entities from multiple target groups respectively, wherein the multiple target groups are based on a plurality of demographical parameters;
construct a connection model based on the predetermined total resource allocation, the predetermined number of communication channels, the multiple total target numbers of connected entities from multiple target groups, and multiple resource distribution parameters associated with the predetermined number of communication channels and the multiple target groups;
receive current connection data corresponding to the multiple target groups from the predetermined number of communication channels in a current period;
learn the multiple resource distribution parameters for the current period from multiple explorations of the predetermined number of communication channels based on corresponding allocated exploration budgets using an online reinforcement learning algorithm;
update the multiple resource distribution parameters for the connection model in a subsequent period based on the current connection data and historical connection data;
determine optimized resource allocations for the predetermined number of communication channels in the subsequent period by maximizing a total number of connected entities from the multiple target groups and minimizing deviation from connection trajectories for the multiple target groups respectively based on multiple updated resource distribution parameters for the connection model and the current connection data using one or more convex optimization algorithms; and
provide the optimized resource allocations to the predetermined number of communication channels in the subsequent period.

19. The non-transitory computer-readable medium of claim 18, further comprising processor-executable instructions configured to cause one or more processors to:
determine the connection trajectories by proportionating the multiple total target numbers of connected entities from the multiple target groups over a total period; and
adjust the connection trajectories based on the current connection data corresponding to the multiple target groups from the predetermined number of communication channels during the current period.

20. The non-transitory computer-readable medium of claim 18, further comprising processor-executable instructions configured to cause one or more processors to:
relax one or more constraints associated with the multiple total target numbers of connected entities from multiple target groups based on the one or more convex optimization algorithms.
